(19) United States
(12) Patent Application Publication
(10) Pub. No.: US 2015/0077241 A1
(43) Pub. Date: Mar. 19, 2015

(54) SYSTEM FOR MONITORING, TRACKING AND RECORDING THE LOCATION OF PERSONNEL

(71) Applicant: Sentinel Offender Services, LLC, Irvine, CA (US)

(72) Inventors: Robert Contestabile, Cota de Caza, CA (US); Steven Durana, San Juan Capistrano, CA (US)

(73) Assignee: Sentinel Offender Services, LLC, Irvine, CA (US)

(21) Appl. No.: 14/030,878

(22) Filed: Sep. 18, 2013

(51) Int. Cl. G08B 25/10; H04W 4/02

(52) U.S. Cl. CPC G08B 25/10; H04W 4/02
USPC 340/502; 340/539.13

(57) ABSTRACT

A personal monitoring system and method is provided which includes a monitoring device including a positioning sensor for identifying and storing position data of the monitoring device and a transceiver. A remote computing unit for receiving proximity signals and position data received from the monitoring device at a predetermined interval. The remote computing unit also receives position data from the monitoring device. A central computer for location data collection receives proximity signals and position data from the remote computing unit at a predetermined interval.

### CROSS-REFERENCE TO RELATED APPLICATIONS

This application claims priority to provisional application 61/704,015 filed Sep. 21, 2012, titled “SYSTEM FOR MONITORING, TRACKING AND RECORDING OF PERSONAL LOCATION.”

### BACKGROUND OF THE INVENTION

The present invention generally relates to systems which provide location tracking, monitoring, and recording of a portable device that is affixed to an individual or other object, and which the device periodically communicates to a remote monitoring station. More particularly, the present invention relates to a tracking device which is capable of recording fixed location data through RF communications with a remote unit (e.g., a base station at the participant's home or at a courthouse), and which is also capable of recording the real time location of an individual or objects through GPS or similar location tracking services and stores the information for subsequent transfer to a centralized monitoring station when the portable device is in communication with a remote unit.

A common use of such tracking devices is to monitor the location and behavior or criminal offenders during probation. For ease of understanding, the term “participant” will be used throughout this application to refer to an individual whose location is being monitored through the use of a portable device. The person or agency that is tasked with monitoring the participant will be referred to as the “monitoring agent” or “monitoring agency.” In the case of probation monitoring, the monitoring agent is a law enforcement officer. In still other possible applications of such portable tracking devices, the monitoring agent may be an employer, while the participant is a lone worker whose driving patterns are being monitored.

Electronic location monitoring and tracking of individuals or objects can be carried out in a number of ways. Location determination of the portable device can be provided using well-known techniques, such as global positioning system (GPS), GLOSNASS, or Galileo satellite systems, terrestrial location based services, such as cellular triangulation, Long Range Navigation (LORAN), or a combination of these systems. Further, in certain system applications, the device makes use of a tamper-resistant strap or similar fastening device to prevent the participant from removing the portable device or altering the function of the portable device without detection.

There are variants of electronic location monitoring and tracking systems for the tracking of monitored individuals, also referred to as participants. These systems fall generally into two categories, fixed location monitoring which only monitors the presence or absence of a participant at a fixed location, and real-time location monitoring systems where the participant wears a GPS enabled device and the location of the participant is reported on a periodic basis to the central monitoring station via cellular connection or a land line. The present invention accomplishes both fixed location monitoring and real-time location monitoring.

Systems which rely upon electronic monitoring at a fixed location such as the individual's home or place of employment can rely upon a land line telephone or cellular telephone link and are commonly known as house arrest systems. These systems utilize a transmitter, typically radio frequency (RF), worn by the individual and a stationary receiver located at the monitoring location. Existing RF transmitters used in offender monitoring do not collect position data, such as GPS location data points.

The worn transmitter transmits a signal a short distance to the receiver located at the monitoring location. The receiver communicates with a central monitoring service (CMS) over standard telephone lines or cellular network. Typically, the central monitoring service is provided by a private contractor who monitors a participant's behavior from a centralized location. In other applications, the CMS may be run by a government agency, employer, or other authority. The CMS can then notify the monitoring agent in the case that the participant appears to have violated the rules of their monitoring program. Similarly, the transmitter may incorporate tamper-detection capabilities, transmitting an alarm to the wearer and to the central monitoring service upon detection of tampering.

The monitoring system of this type is limited in that it can only provide an indication of the presence or absence of the individual at the monitored location at a given time. This type of system cannot offer location information if the individual leaves the monitored location.

Real-time location tracking is typically accomplished using either a one-piece unit which contains a GPS tracking module and a cellular communications module attached to the ankle of the participant, or a two piece unit in which the GPS and cellular modules are housed in a removable device linked to an ankle attached device via a coded RF link. These devices typically transmit the participant location in real-time or near real-time to the central monitoring station via a cellular connection. The cellular transmission can upload on a schedule, at selected time intervals, or near constant upload. Exclusion zones stored on the device (on-board-zones) or stored at the CMS can cause a decrease or increase in the frequency of the transmission of location information. In addition, one or more stationary units can be combined with these devices to allow for the monitoring at a particular location via RF transmission between the device worn by the participant and the stationary unit. Sometimes a stationary unit with docking/charging functions is provided for connection with and recharging of the removable portion of a two piece device.

### BRIEF SUMMARY OF THE INVENTION

The present invention includes a portable unit which is worn by a participant which includes a positioning module for collection of real-time location data. The present invention also includes a stationary unit (also called a remote unit) maintained, for example, in a dwelling or work place, which is connected for communication with the central monitoring station. The portable unit stores the real time location and time information received from a positioning system to track the location of the device when it is not in proximity to the stationary unit, such as when a participant is out of the home. When the portable unit comes in proximity to the stationary unit, a wired or wireless link (such as RF or blue tooth) uploads the out-of-home information which can then be transmitted to the central monitoring station to provide a record of the participant's activity. When in proximity of the stationary unit, the unit converts to a standard house arrest unit and no longer collects position data. Once the unit departs from the stationary unit position data collection is resumed.

The present invention is an improvement over the prior art in that the unit stores information while away from the unit, thus saving costs in data transmission. Likewise, because the unit is not constantly broadcasting information while away from home, the unit offers extended battery life of several days—an improvement over current devices that require much more frequent charging. Another advantage of this invention is that because it is not constantly reporting information in real time, the monitoring agency is relieved from the burden of constantly monitoring the participant's behavior.

### BRIEF DESCRIPTION OF THE DRAWINGS

FIG. 1 illustrates a block diagram of the monitoring device according to an embodiment of the present invention.

FIG. 2 illustrates an embodiment of the monitoring system according to an embodiment of the present invention.

### DETAILED DESCRIPTION OF THE INVENTION

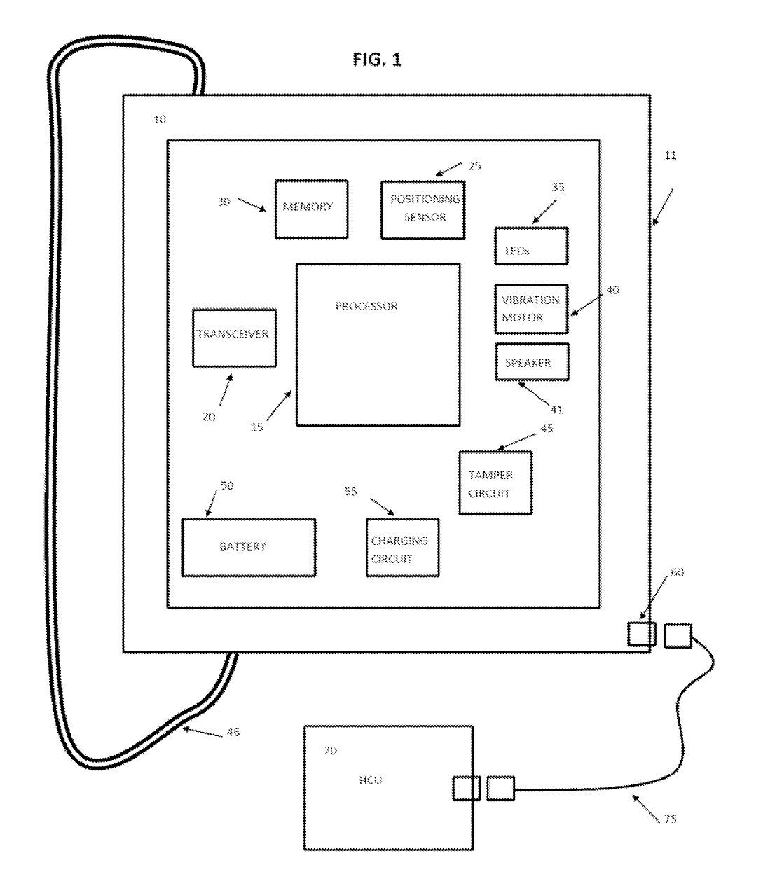

FIG. 1 illustrates a monitoring system according to an embodiment of the present invention. The monitoring system includes a monitoring device 10 and a home curfew unit (HCU) 70. The monitoring device includes a housing 11, a processor 15, a radio frequency (RF) transceiver 20, a positioning sensor 25, a memory unit 30, a tamper circuit 45, a battery 50, a charging circuit 55, and a data/charging port 60. The HCU 70 often includes a data/charging cable 75. In other embodiments, the HCU 70 communicates with the monitoring device 10 wirelessly. The HCU 70 may also be referred to as a remote computing unit. The location of the structures shown in FIG. 1 is illustrative only; other arrangements of the structures are possible and contemplated by this invention.

The housing 11 contains the processor 15, the transceiver 20, the positioning sensor 25, the memory unit 30, the tamper circuit 45, the battery 50, the charging circuit 55, and the data/charging port 60. The processor 15 is in data connection with the transceiver 20, the positioning sensor 25, the memory unit 30, the tamper circuit 45, and the data/charging port 60. The battery is in electrical connection with the processor 15, the transceiver 20, the positioning sensor 25, the tamper circuit 45 and the charging circuit 55. The charging circuit is in electrical connection with the data/charging port 60.

In operation the data/charging port 60 is connected to a power source during charging. The data/charging port supplies electricity to the charging circuit 55 which, depending on the power source, rectifies and regulates alternating current (AC) to direct current (DC) and supplies electricity to the battery 50, or simply regulates the DC and supplies the electricity to the battery 50. The charging circuit 55 regulates the power supplied to the battery 50 to maximize the charge and battery life expectancy. The battery 50 supplies electrical power to the processor 15, transceiver 20, positioning sensor 25, and tamper circuit 45.

The processor 15 at a predetermined interval sends a request to the transceiver 20 to transmit a proximity signal at a predetermined interval. The proximity signal is limited in range and is to be received by the HCU 70 (remote computing unit). A proximity signal is a signal (typically a carrier signal) communicated between the HCU 70 and the monitoring device 10 that tells the HCU 70 that the monitoring device 10 is within a certain preset distance to the HCU 70. The HCU 70 is placed in a central location within the area that the participant will be monitored, such as the home, but could be placed in other locations such as place of employment or other remote locations. When the HCU 70 receives the proximity signal from the monitoring device 10 it returns an acknowledgement signal to the monitoring device 10. The transceiver 20 of the monitoring device 10 receives the acknowledgement signal. The transceiver 20 sends the acknowledgment signal to the processor 15.

If the processor 15 does not receive the acknowledgement signal, the processor 15 requests position data from the positioning sensor 25. The positioning sensor 25 uses cellular phone triangulation, satellite positioning, or other methods or determination position to get a “fix” or location data on the monitoring device 10. In the preferred embodiment, the positioning sensor 25 will first attempt to get positioning data using GPS. In this embodiment, it is contemplated that a GPS antenna (not shown in FIG. 1) in communication with the positioning sensor 25 will also be present in the portable unit. If the sensor is unable to pick up a GPS signal, it will then make use of alternate sources of positioning data, such as by cellular triangulation. The location data is sent from the positioning sensor 25 to the processor 15. The processor 15 sends the location data to memory unit 30 for later retrieval. In a preferred embodiment, the memory unit utilizes flash memory. The processor 15 repeats the request of location data at a predetermined interval until an RF acknowledgement signal is received, storing the location data in memory unit 30 each time for later retrieval.

The positioning sensor 25 is active at all times when the participant is out of proximity of the HCU 70. When the positioning sensor 25 is unable to get a fix, the last location data is repeated to the processor 15 and stored in the memory unit 30. This prevents the battery 50 from being drained while the sensors are out of range or communication. Alternatively, the positioning sensor 25 can operate independent of the transceiver 20 receiving an acknowledgement signal.

In one embodiment, the tamper circuit 45 is connected to a retention strap 46 to hold the monitoring device 10 to the person using the device. The retention strap 46 is equipped with one or more means to verify that the unit is not removed, such as fiber optic, electronic, or magnetic means. The monitoring device is intended to be worn by the participant 24 hours a day and not removed, except by an authorized person.

When the HCU 70 and the monitoring device 10 come in close proximity to each other, a connection is established between the HCU 70 and the monitoring device 10. Thereupon the monitoring device 10 will transmit information to the HCU 70. The processor 15 requests the location data from the memory unit 30. In response to the request the memory unit 30 sends the location data to the processor 15. The processor sends the location data to the HCU wirelessly. In an alternative embodiment, the HCU 70 will first send a request to the processor 15 for all stored location data, after which the processor initiates the sequence described here.

Alternatively, the monitoring device 10 can be in electrical and data communication with the HCU 70 by connecting the charging/data cable 75 between the HCU 70 and the data port 60, of the monitoring device 10. The charging/data cable 75 establishes a data communication path from the processor 15 to the HCU 70. Once a connection is established between the HCU 70 and the monitoring device 10, the monitoring device will transmit information to the HCU 70. The processor 15 requests the location data from the memory unit 30. In response to the request the memory unit 30 sends the location data to the processor 15. The processor sends the location data to the HCU through the charging/data cable 75. In an alternative embodiment, the HCU 70 will first send a request to the processor 15 for all stored location data, after which the processor initiates the sequence described here. The HCU 70 then sends the data to the CMS.

In one embodiment, the charging/data cable 75 provides electricity to the charging circuit 55 to power and charge the battery 50. Alternatively, the data/charging cable 75 may also be connectable to a standard wall outlet to charge the battery. In yet other embodiments, the monitoring device may be charged through magnetic induction or other suitable methods for charging devices.

In one embodiment, the monitoring device 10 includes a light emitting diode (LED) 35 or a several LEDs. The LEDs 35 are in electrical communication with the processor 15 and the battery 50. The LEDs 35 can be used to communicate a variety of data, including but not limited to battery life, RF link with the HCU 70, positioning signal, and tamper circuit status.

The charging circuit 55 is in data communication with the processor 15. The charging circuit 55 monitors the battery 50 life remaining and sends the data to the processor 15. The processor 15 sends a signal lighting the appropriate color or number of LEDs 35 to indicate to the participant the battery life remaining. If the processor 15 has received the acknowledgement signal from the transceiver 20 the process will send a signal to an LED 35 to light, indicating the RF link is current. If the processor 15 does not receive the next acknowledgement signal form the transceiver 20, the processor 15 sends a signal to the LED bank 35 to turn off the RF link LED or in addition turn on a “no RF link” LED. As the participant travels and periodic location data is obtained the signal strength can be sent to the processor 15. The processor 15 sends a signal to the LEDs 35 to indicate the strength of the signal to the participant. If the tamper circuit 45 is operating normally (no tampering detected), the processor 15 may not light a LED 35 or it may send a signal to the LEDs 35 to light a normal light.

In one embodiment, if the tamper circuit 45 detects tampering the processor 15 will send a signal to the LEDs 35 to light a tamper light, to indicate to the participant and monitoring service that the tampering has occurred. In another embodiment, the GPS signal strength is indicated by the LEDs 35.

In one embodiment the monitoring device 10 includes a vibration motor 40. The vibration motor 40 is in electrical connection with the processor 15 and the battery 50. The vibration motor 40 can be used to communicate a variety of data to the participant, including but not limited to battery charge complete, loss of RF link, tamper detection, and pre-tamper warning. The vibration motor can also be used to signal zone violations—for example if the participant travels too close to a school, bar, or other area where the participant is not allowed to be.

As an example, the charging circuit 55 sends a signal to the processor 15 indicating that the battery 50 is at full charge. The processor 15 sends a signal to the vibration motor 40 to turn on for a predetermined period. The circumstances will usually let the participant know what the vibration means, but if the LED 35 is equipped it will also indicate the reason for the vibration. When the participant moves beyond the range of RF link to the HCU 70, the processor 15 no longer receives the acknowledgement signal from the transceiver 20. The processor 15 sends a signal to the vibration motor 40 to turn on for a predetermined period. In another example, if the tamper circuit is equipped with a pre-tamper function, the tamper circuit detects a strain on the retention strap 46. The tamper circuit 45 sends a signal to the processor 15. The processor sends a signal to the vibration motor 40 to turn on for a predetermined period.

In one embodiment, the monitoring device includes a speaker 41. The speaker 41 is in electrical connection with the battery 50 and the processor 15. The speaker 41 operates in substantially the same way as the vibration 40 motor, but can have different tones, noises, or words to signal different events.

In another embodiment, the transceiver 20 of the monitoring device 10 is capable of wireless communication with the HCU 70 using the Bluetooth® standard, WiFi, or other similar means of communication. In the preferred embodiment, the transceiver 20 makes use of 2.4 gHz transmissions. The transceiver 20 is in data communication with the HCU 70. When the monitoring device 10 is within range of the HCU 70, the processor 15 request the transceiver 20 to establish communication with the HCU 70. The HCU 70 then requests the location data from the monitoring device 10. The transceiver 20 sends the request to the processor 15. The processor 15 requests the stored location data from the memory unit 30. The processor 15 sends the location data to the transceiver 20. The transceiver 20 sends the location data to the HCU 70 by wireless communication means. The HCU 70, in turn, sends the data to the CMS, as described below.

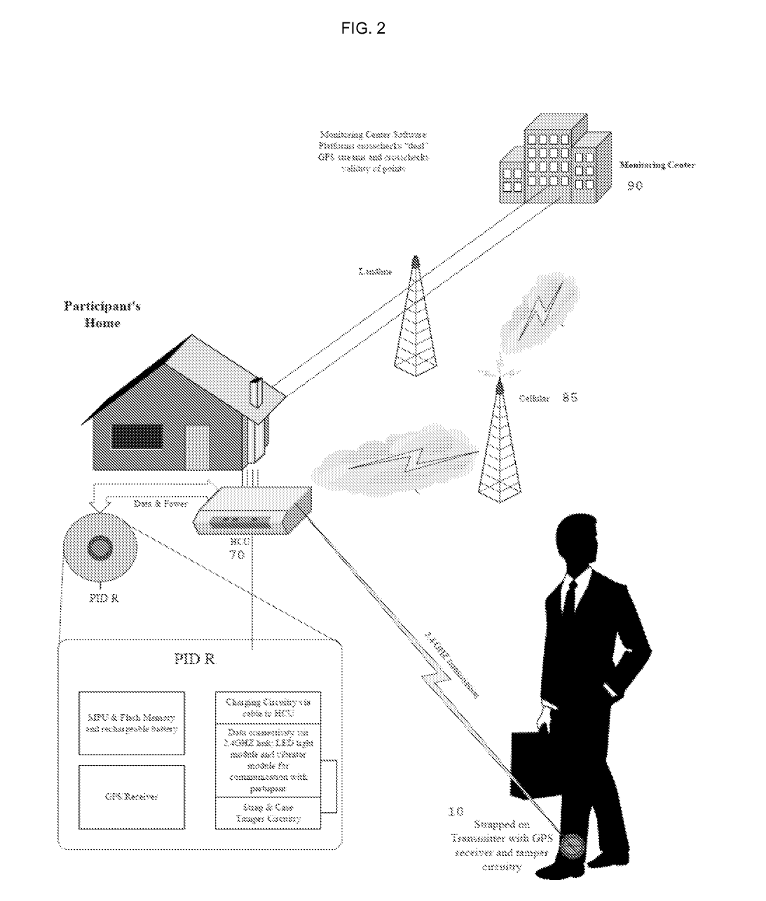

FIG. 2 illustrates an embodiment of the monitoring, recording and tracking system. The monitoring, recording and tracking system includes a monitoring device 10, a home curfew unit (HCU) 70, and a central monitoring station (CMS) 90.

The monitoring device 10 is in electrical/data communication with the HCU 70. The HCU 70, in turn, is in communication with a central computing unit, the CMS 90. The monitoring device 10 sends a short range RF or wireless transmission or proximity signal to the HCU 70. When the HCU 70 is in sufficient proximity to receive the signal, the HCU 70 sends an acknowledgement signal back to the monitoring device 10. The HCU 70 converts the data into status data consisting of a date, time, and status of the participant (e.g., present or not present). Once the HCU 70 has received and converted the data, the HCU 70 sends the status data to the CMS 90. The CMS 90 monitors the data from various units and alerts authorities or interested parties when the participant is not within the range of the RF transmission. Similarly the HCU 70 sends an immediate signal to the CMS 90 in the event a tamper is detected on the monitoring device 10.

When the participant leaves the RF transmission range the positioning system of the invention is activated. As described above, the position system utilizes a cellular, satellite, or similar positioning system to identify the location of the participant. The location data is recorded by the monitoring device 10 while the participant is out of range of the HCU 70. The location data is stored in the monitoring device 10 and downloaded to the HCU 70 at a later time. The HCU 70 sends the location data to the CMS 90. The CMS 90 evaluates and stores the location data to verify that the participant is in authorized locations and compare time and place to offenses occurring in areas traveled by the participant.

When the monitoring device 10 is out of RF transmission range the monitoring device 10 will activate a positioning function. In the preferred embodiment, the positioning sensor 25 will first attempt to get positioning data using GPS. If the sensor is unable to pick up a GPS signal, it will then make use of alternate sources of positioning data, such as by cellular triangulation. The location data is stored in memory. When the participant connects the charging/data cable between the monitoring device 10 and the HCU 70, or connects wirelessly to the HCU, the location data is sent to the HCU 70. The HCU 70 sends the location data to the CMS 90. The CMS 90 uses the data to verify the location data from the positioning system data generated by the monitoring system 10.

In some embodiments of the prior art, the monitoring systems employed a portable GPS unit to verify location of the participant. This system relied on the participant to voluntarily wear the GPS device and remember each time they left a home location. The monitoring, recording, and tracking system of the present invention has a built in positioning sensor to ensure the location data is recorded while the participant is wear the monitoring device away from the HCU.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A monitoring system including:
monitoring device, wherein the monitoring device includes a transceiver and a position sensor for identifying and storing position data of the monitoring device;
a remote computing unit for receiving proximity signals and position data, wherein the remote computing unit receives said proximity signals from the monitoring device at a predetermined interval, wherein the remote computing unit also receives position data from the monitoring device; and
a central monitoring computer system for position data collection, wherein the remote computing unit sends proximity signals and position data to the central monitoring computer system at a predetermined interval.

2. The monitoring system of claim 1, wherein the monitoring device communicates wirelessly with the remote computing unit.

3. The monitoring system of claim 2, wherein the monitoring device communicates using 2.4 gHz wireless communication technology.

4. The monitoring system of claim 1, further including a data cable;
wherein the data cable electrically connects the monitoring device to the remote computing unit; and
wherein the position data is transmitted from the monitoring device to the remote computing unit through the data cable.

5. The monitoring system of claim 1, wherein the proximity signals are radiofrequency transmissions.

6. The monitoring system of claim 1, wherein the proximity signals are Bluetooth transmissions.

7. The monitoring system of claim 1, wherein the remote computing unit sends an alarm signal to said central monitoring computer system upon a failure to receive the proximity signals.

8. The monitoring system of claim 1, wherein the remote computing unit sends an acknowledgement of the proximity signals to the monitoring device.

9. The monitoring system of claim 8, wherein the monitoring device further includes an alarm, wherein the monitoring device activates the alarm upon failure to receive the acknowledgement signal.

10. The monitoring system of claim 9, wherein the alarm is a speaker, wherein the speaker emits a sound in response to activation.

11. The monitoring system of claim 9, wherein the alarm is a vibration motor, wherein the vibration motor vibrates in response to activation.

12. The monitoring system of claim 1, wherein the monitoring device further includes a retention strap and a tamper circuit, wherein a tamper alert transmission is sent to the remote computing unit in response to a disruption in the retention strip, wherein the remote computing unit sends a tamper alert transmission to the central computing unit in response to receiving the tamper alert transmission.

13. The monitoring system of claim 1, wherein the monitoring device further includes a rechargeable battery.

14. The monitoring system of claim 1, wherein the monitoring device further includes memory for storage of position data.

15. A method of monitoring and recording the location of a participant, said method including:
attaching a monitoring device to a participant; wherein the monitoring unit has a position sensor and a transceiver;
transmitting a proximity signal to a remote computing device from the monitoring device at a predetermined interval;
detecting position data on the position sensor;
storing the position data in the monitoring device;
transmitting the position data from the monitoring device to the remote computing unit; and
transmitting the position data to a central monitoring computer system.

16. The method of claim 15, wherein the monitoring device has a retention strap and a tamper circuit; further including;
transmitting a tamper signal from the monitoring device to the remote computing device in response to tampering of the retention strap; and
transmitting said tamper signal from the remote computing unit to the central monitoring computer system.

17. The method of claim 15 further including:
sending an acknowledgement signal from the remote computing unit to the monitoring device in response to receiving a proximity signal;
activating the position sensor in response to not receiving the acknowledgement signal.

18. The method of claim 17, wherein the monitoring device includes an alarm, further including;
activating the alarm in response to the monitoring device not receiving the acknowledgement signal from the remote computing unit.

19. The method of claim 16, wherein the monitoring device includes an alarm, further including;
activating the alarm in response to a disruption to the tamper circuit.
